(19) United States
(12) Patent Application Publication
(10) Pub. No.: US 2026/0011279 A1
(43) Pub. Date: Jan. 8, 2026

(54) VOLTAGE COMPENSATION METHOD, DEVICE, TERMINAL DEVICE, AND COMPUTER READABLE STORAGE MEDIUM THEREOF

(71) Applicants: Huizhou China Star Optoelectronics Display Co., Ltd., Huizhou, Guangdong (CN); TCL China Star Optoelectronics Technology Co., Ltd., Shenzhen, Guangdong (CN)

(72) Inventor: Qian WANG, Huizhou, Guangdong (CN)

(21) Appl. No.: 18/571,749

(22) PCT Filed: Oct. 31, 2023
(86) PCT No.: PCT/CN2023/128007

§ 371 Date: Dec. 19, 2023

(30) Foreign Application Priority Data
Mar. 28, 2023 (CN) 202310350859.4

(51) Int. Cl. G09G 3/20

(52) U.S. Cl. CPC G09G 3/2007; G09G 2320/0233; G09G 2320/0242

(57) ABSTRACT

The present disclosure provides a voltage compensation method, a device, a terminal device and a computer readable storage medium. The method includes: obtaining pixel information and position information of a target pixel to be compensated; determining an area compensation parameter corresponding to the target pixel according to the pixel information; performing a brightness compensation on the target pixel according to the position information of the target pixel in a display panel and the area compensation parameter. The voltage compensation method determines an area compensation parameter according to the pixel information after determining the pixel information of the target pixel point, so as to obtain a target display area in a display panel. After that, a voltage compensation operation is performed on the target display area. Accordingly, the voltage compensation does not need to perform individual voltage compensation for each pixel, thereby reducing the computational burden.

### FIELD OF THE DISCLOSURE

The present disclosure relates to an electronic device, and more particularly, to a voltage compensation method, a device, a terminal device, and a computer readable storage medium thereof.

### BACKGROUND

With the development of display technology, the performance of display panels is getting better and better. In particular, in terms of brightness, in order to have a better display effect, it is necessary to maintain uniformity in the displayed image. Conventionally, the solution is to perform a charging compensation on each pixel in the display panel, so that the pixel with lower brightness can have a longer charging time, so as to ensure that the pixel with lower brightness can have a better brightness and also ensure the brightness uniformity of the display.

However, with the development of display technology, the resolution of display panels is getting higher and higher, and the display panel is also getting larger and larger. Therefore, the display panel has more and more pixels. In this way, when the display panel needs to determine whether each pixel needs to be charged and compensated in turn and then decrease/increase the voltage for each pixel that needs to be charged and compensated, and the computation amount is larger, and the computation burden is heavier.

### SUMMARY

One objective of an embodiment of the present disclosure is to provide a voltage compensation method, which could determine the pixel information of the pixel to be compensated and then determine the compensation voltage of the corresponding display area accordingly. This method does not need to calculate whether each pixel in the entire display panel needs the voltage compensation, and thus the computational burden could be reduced.

In a first aspect, an embodiment of the present disclosure provides a voltage compensation method. The compensation method comprises:
obtaining pixel information and position information of a target pixel to be compensated;
determining an area compensation parameter corresponding to the target pixel according to the pixel information; and
performing a brightness compensation on the target pixel according to the position information of the target pixel in a display panel and the area compensation parameter.

In some embodiment of the present disclosure, the pixel information comprises a first binding gray value of the target pixel, and the step of determining the area compensation parameter corresponding to the target pixel according to the pixel information comprises:
determining whether the target pixel has a matched target adjacent pixel;
when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel; and
determining the area compensation parameter corresponding to the target pixel according to a gray difference between the first binding gray value and the adjacent binding gray value.

In some embodiment of the present disclosure, the step of determining the area compensation parameter corresponding to the target pixel according to the pixel information comprises:

the gray difference is negatively correlated with a number of pixels in the display area corresponding to the area compensation parameter; or, the gray scale difference is positively correlated with a number of areas in the display area corresponding to the area compensation parameter.

In some embodiment of the present disclosure, the voltage compensation method further comprising following steps after the step of determining whether the target pixel has a matched target adjacent pixel:
when the target pixel does not have a matched target adjacent pixel, obtaining a preset reference binding gray value; and
determining the area compensation parameter corresponding to the target pixel according to a gray difference between the first binding gray value and the reference binding gray value.

In some embodiment of the present disclosure, the step of performing the brightness compensation on the target pixel according to the position information of the target pixel in the display panel and the area compensation parameter comprises:
according to the position information of the target pixel in the display panel, determining a regional center point;
determining a target display area according to the regional center point and the area compensation parameter; and
performing the brightness compensation on the target pixel in the target display area.

In some embodiment of the present disclosure, the step of performing the brightness compensation on the target pixel comprises:
obtaining a preset weight corresponding to the target pixel; and
compensating a gray value of the target pixel according to the preset weight.

In some embodiment of the present disclosure, the step of compensating the gray value of the target pixel according to the preset weight comprises:
determining a second binding gray value of the target pixel, wherein the second binding gray value represents the preset reference binding gray value or an adjacent binding gray value of a matched target adjacent pixel;
comparing the first binding gray value with the second binding gray value;
when the first binding gray value is greater than the second binding gray value, obtaining a corresponding first preset weight and compensating the gray value of the target pixel accordingly, where the first preset weight is a positive number; and
when the first binding gray value is then than the second binding gray value, obtaining a corresponding second preset weight and compensating the gray value of the target pixel accordingly, where the second preset weight is a negative number.

In a second aspect, another embodiment of the present disclosure further provides a voltage compensation device. The voltage compensation device includes:
an obtaining module, configured to obtain pixel information and position information of a target pixel to be compensated;
a determining module, configured to determine an area compensation parameter corresponding to the target pixel according to the pixel information; and
a compensation module, performing a brightness compensation on the target pixel according to the position information of the target pixel in a display panel and the area compensation parameter.

In a third aspect, another embodiment of the present disclosure further provides a terminal device. The terminal device comprises: a memory, storing a computer program; and a processor, configured to execute the computer program to perform the aforementioned voltage compensation method.

In a fourth aspect, another embodiment of the present disclosure further provides a computer readable storage medium storing computer program instructions executable by a processor to perform the aforementioned voltage compensation method.

In an embodiment, the voltage compensation method determines an area compensation parameter according to the pixel information after determining the pixel information of the target pixel point, so as to obtain a target display area in a display panel. After that, a voltage compensation operation is performed on the target display area. Accordingly, the voltage compensation does not need to perform individual voltage compensation for each pixel, thereby reducing the computational burden.

### BRIEF DESCRIPTION OF THE DRAWINGS

In order to more clearly illustrate the technical solution in the embodiment of the present disclosure, the following will be a brief introduction to the drawings required in the description of the embodiment. Obviously, the drawings described below are only some embodiments of the present disclosure, for those skilled in the art, without the premise of creative labor, may also obtain other drawings according to these drawings.

FIG. 1 is a diagram of a voltage compensation system according to an embodiment of the present disclosure.

FIG. 2 is a flow chart of a voltage compensation method according to an embodiment of the present disclosure.

FIG. 3 is a functional block diagram of a voltage compensation device according to an embodiment of the present disclosure.

FIG. 4 is a functional block diagram of a terminal device according to an embodiment of the present disclosure.

### DETAILED DESCRIPTION OF PREFERRED EMBODIMENTS

To help a person skilled in the art better understand the solutions of the present disclosure, the following clearly and completely describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

The term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plural” is two or more, unless otherwise specifically defined.

In this application, the word “exemplary” is used to mean “serving as an example, illustration, or explanation.” Any embodiment described herein as “exemplary” is not necessarily to be construed as preferred or advantageous over other embodiments. At the same time, it can be understood that in the specific implementation of this application, user information, user data and other related data are involved. When the above embodiments of this application are applied to specific products or technologies, user permission or consent needs to be obtained. And the collection, use and processing of relevant data need to comply with relevant laws, regulations and standards of relevant countries and region.

The following description is presented to enable any person skilled in the art to make and use the present disclosure. In the following description, details are set forth for the purpose of explanation. It will be understood that one of ordinary skill in the art will recognize that the present disclosure may be practiced without these specific details. In other instances, well-known structures and processes have not been described in detail to avoid obscuring the description of the application with unnecessary detail. Thus, this application is not intended to be limited to the embodiments shown but is to be accorded the broadest scope consistent with the principles and features disclosed herein.

The present disclosure provides a voltage compensation method, device, terminal device and computer readable storage medium, which are described in detail below.

Please refer to FIG. 1. FIG. 1 is a diagram of a voltage compensation system according to an embodiment of the present disclosure. The voltage compensation system may comprise a terminal device 100 and a storage device 200. The storage device 200 can transmit data to the terminal device 100. As shown in FIG. 1, the terminal device 100 could access and execute the voltage compensation program stored in the storage device 200 perform a voltage compensation method of the present disclosure.

In the embodiment of the present disclosure, the terminal device 100 includes, but is not limited to, a desktop computer, a portable computer, a network server, a handheld computer (Personal Digital Assistant, PDA), a tablet computer, a wireless terminal device, an embedded device, etc.

In the embodiment of the present disclosure, communication between the terminal device 100 and the storage device 200 can be achieved through any communication protocols, including but not limited to, the 3rd Generation Partnership Project (3GPP), Long Term Evolution (LTE), Worldwide Interoperability for Microwave Access (WiMAX), or TCP/IP Protocols, User Datagram Protocol (UDP), etc.

It is noted that the diagram of the voltage compensation system shown in FIG. 1 is only an example. The voltage compensation system described in this embodiment is only for the purpose of more clearly illustrating the technical solution of the embodiment of the present disclosure, and do not constitute the limitation of the present disclosure. One having ordinary skills in the art can understand that with the evolution of the voltage compensation system and the emergence of new business scenarios, the technical solution provided in the embodiment of the present disclosure could be equally applicable to similar technical problems.

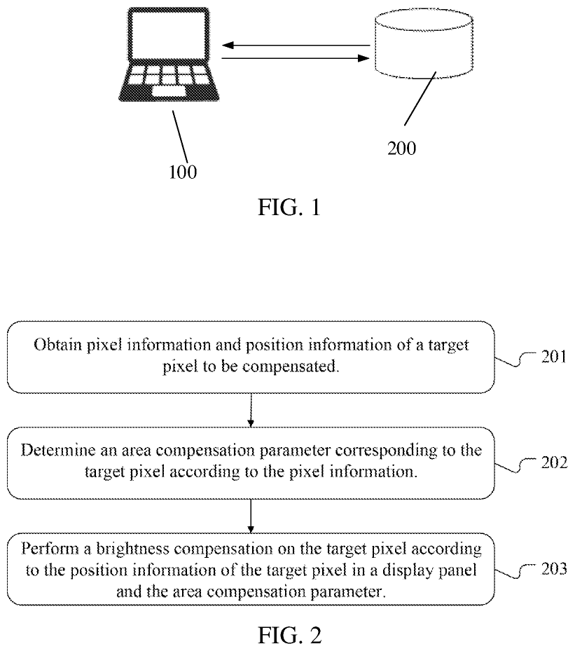

Please refer to FIG. 2. FIG. 2 is a flow chart of a voltage compensation method according to an embodiment of the present disclosure. The voltage compensation method comprises following steps 201-203.

Step 201: obtaining pixel information and position information of a target pixel to be compensated.

In this embodiment, the display panel could be a display panel of any model. Here, the target pixel may be any pixel in the display panel. The pixel information may include the relevant information of the target pixel, including color information, brightness information, etc.; and the position information is characterized by the coordinate of the target pixel according to the display panel. For example: when the display panel is a display panel with 4K resolution, and the 4K resolution is 3840×2160, the abscissa range of the display panel is 0 to 3840, and the ordinate range is 0 to 2160.

Step 202: determining an area compensation parameter corresponding to the target pixel according to the pixel information.

In this embodiment, the area compensation parameter is a parameter, for determining the size of the area that needs voltage compensation. The area compensation parameter is configured to determine a range of the position of the target pixel to perform the voltage compensation according to the position of the target pixel. Specifically, it can be understood that when an area compensation parameter is determined, than a target display area, that uses the target pixel as the center and the area compensation parameter as the radius, could be determined.

From the above steps, the pixel information can comprise color information, brightness information, etc. Therefore, after obtaining the pixel information, the area compensation parameter can be determined according to the specific displayed screen of the display panel. For example, when the color of the target pixel is red, and the brightness parameter indicates that the brightness of the target pixel is low, and when the overall display screen of the display panel is also red, but the overall display brightness of the display panel is high, the target pixel needs to be charged and compensated to maintain a certain uniformity between the brightness of the target pixel and the brightness of the overall picture.

However, when an image is displayed, pixels are usually displayed together with surrounding pixels. For example, the target pixel is a pixel in the sunset image. But when the sunset image is displayed, the target pixel and nearby pixels display a sunset area, and the brightness is low. In order to make the brightness of the sunset area and the overall sunset scene look more uniform, you need to charge and compensate the sunset area to improve the brightness. In this case, you can start the process of determining the area compensation parameter based on the brightness difference between the target pixel and the overall image when the brightness difference exceeds a certain brightness difference threshold. After the process of determining the region compensation parameter, the size of the specific area compensation parameter can be determined based on the current color information of the target pixel.

For example, when the color information represents cool tones, it can correspond to a preset small area compensation parameter. If the color information represents warm tones, it can correspond to a preset larger area compensation parameter. The reason is that most of the cool colors are dark colors, such as black, blue, etc., after the brightness enhancement of these colors, the visual effect is stronger, so a small area compensation parameter is needed to avoid obtaining a large display area, so that when the charging compensation is performed, other pixels with normal brightness can be avoided as much as possible to be included in the display area. On the contrary, most of the warm colors are bright colors, such as red, yellow, etc., after the brightness enhancement of these colors, the visual effect will not be particularly obvious, so a large area compensation parameter can be appropriately selected, so that when the charging compensation is performed, even when the pixels of normal brightness are included in the display area, after the brightness is enhanced, the visual effect will not be greatly deviated.

Step 203: performing a brightness compensation on the target pixel according to the position information of the target pixel in a display panel and the area compensation parameter.

In this embodiment, the target display area can be determined after determining the area compensation parameter and the position information of the target pixel, such as position coordinate. For example, when an area compensation parameter is determined, the target display area could be determined using the target pixel as the center of the circle and the area compensation parameter as the radius.

After the target display area is determined, the brightness difference between the target pixel and the overall picture is determined in the preceding step. In this case, the brightness of the target pixel is then compensated according to the brightness difference. However, in this case, the brightness compensation is performed on the target display area. That is, the overall brightness compensation is performed on the target display area. For example, when the brightness of the target pixel is A, and the brightness of the overall picture is B, the brightness B could be used to display the entire target pixel area. In other words, the voltage corresponding to the brightness B could be used to perform the voltage compensation on the target display area.

The voltage compensation method provided in the present disclosure could determine an area compensation parameter according to the pixel information after determining the pixel information of the target pixel point, so as to obtain a target display area in a display panel. After that, the voltage compensation could be performed on the target display area. Therefore, there is no need to perform independent voltage compensation for each pixel, thereby reducing the computational burden.

In order to better realize the embodiment of the present disclosure, in an embodiment, the pixel information comprises a first binding gray value of the target pixel, and the step of determining the area compensation parameter corresponding to the target pixel according to the pixel information comprises:

determining whether the target pixel has a matched target adjacent pixel; when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel; and determining the area compensation parameter corresponding to the target pixel according to a gray difference between the first binding gray value and the adjacent binding gray value.

In the above embodiment, the pixel information comprising color information and brightness information is provided, and a method for determining the area compensation parameter is provided. According to an embodiment, a method for determining an area compensation parameter by relying on fewer parameters, such as the binding gray value, is also disclosed. It should be noted that the binding gray value is a gray value set for the pixel row or pixel column. In a display panel, the pixel row or pixel column where a pixel is located corresponds to a binding gray value, which can be used as a reference for a display to display the screen accordingly. For example, when the target pixel receives a display task to display a screen with a gray value C, because the binding gray value of the pixel row or the pixel column where the target pixel is located is D, the target pixel will be displayed according to the gray value C and the binding gray value D, so that the gray value E is displayed.

In this embodiment, a preset matching rule may be used to detect whether the target pixel has an adjacent and previous pixel column. If it exists, the target pixel will have a matched target adjacent pixel. In this case, the binding gray value of the matched target adjacent pixel is obtained, and the binding gray value is the gray value bound to the pixel column where the target adjacent pixel is located. Here, the first gray binding value of the target pixel can be the binding grayscale value of the pixel row or the pixel column where the target pixel is located. Then, a difference between the first binding gray value and the adjacent binding gray value is determined. In this case, two difference thresholds, the difference threshold a and the difference threshold b, can be preset. When the difference is less than the difference threshold a, it corresponds to an area compensation parameter 1. When the difference is between the difference threshold a and the difference threshold b, it corresponds to an area compensation parameter 2. When the difference is greater than the difference threshold b, it corresponds to an area compensation parameter 3. Here, the area compensation parameter 1 can be a parameter of 3×5 range size, the area compensation parameter 2 can be a parameter of 3×17 range size, and the area compensation parameter 3 can be a parameter of 5×33 range size.

In order to better realize the embodiment of the present disclosure, in one embodiment, the step of determining whether the target pixel has a matched target adjacent pixel according to the preset matching rules comprises:

determining a target pixel row in which the target pixel is located; obtaining a previous row adjacent to the target pixel row; and determining a pixel in the previous row as the matched target adjacent pixel that matches the target pixel.

In order to meet different actual conditions, in this embodiment, a matching rule for determining whether the target pixel has an adjacent and previous pixel row. Specifically, this rule could determine whether there is an adjacent and previous pixel row of the target pixel. If it exists, the target pixel has a matched target adjacent pixel. At this time, the binding gray value of the target adjacent pixel is obtained. The binding gray value is the gray value of the target adjacent pixel row where the target adjacent pixel is located. Then, the difference between the first binding gray value and the adjacent binding gray value is determined. Same as the above embodiment, two difference thresholds, the difference threshold a and the difference threshold b, can be preset in this embodiment. When the difference is less than the difference threshold a, it corresponds to an area compensation parameter 1, when the difference is between the difference threshold a and the difference threshold b, it corresponds to an area compensation parameter 2, and when the difference is greater than the difference threshold b, it corresponds to an area compensation parameter 3. Here, the region compensation parameter 1 can be a parameter of 3×5 range size, the region compensation parameter 2 can be a parameter of 3×17 range size, and the region compensation parameter 3 can be a parameter of 5×33 range size.

As to whether there is a previous pixel row adjacent to the target pixel row, it can be determined by the identifier corresponding to each pixel row in the display panel. For example, in a 4K display panel, i.e., a display panel of 3860×2160, 3860 represents the number of pixel rows, so each pixel row corresponds to a pixel row identifier, so that only the first pixel row does not have an adjacent previous pixel row, so when the obtained pixel row identifier represents the first pixel row, there is no adjacent previous pixel row, and all the other pixel row identifiers have adjacent previous pixel rows.

In one embodiment, after the step of determining whether the target pixel has a matching target adjacent pixel, the method further comprises:
when the target pixel does not have a matched target adjacent pixel, obtaining a preset reference binding gray value; and determining the area compensation parameter corresponding to the target pixel according to a gray difference between the first binding gray value and the reference binding gray value.

According to the above embodiment, when determining whether the target pixel has a matched adjacent pixel, it is necessary to detect whether the target pixel has an adjacent pixel in an adjacent column/row. However, when the target pixel is a pixel in the first column/row, there is no adjacent and preceding column/row of pixels. In this case, a reference binding gray value needs to be preset to calculate the gray value difference. After obtaining the gray value difference, the area compensation parameter can be determined according to the above embodiment and further details are omitted here.

In order to better implement the embodiment of the present disclosure, in an embodiment of the present disclosure, the step of performing the brightness compensation on the target pixel according to the position information of the target pixel in the display panel and the area compensation parameter comprises:
according to the position information of the target pixel in the display panel, determining a regional center point; determining a target display area according to the regional center point and the area compensation parameter; and performing the brightness compensation on the target pixel in the target display area.

In the above embodiment, the coordinate of the target pixel is used as the center of the circle and the area compensation parameter is used as the radius to obtain a circular target display area. However, in the actual practice, the display panel and the display screen are usually rectangular. Therefore, when the target display area is circular, it may not match the rectangular display panel. In order to solve this issue, the area compensation parameter can be a region compensation parameter that characterizes a rectangular region. The area compensation parameter in the above embodiment can be 3×5, 3×17, and 5×33. In this case, the coordinate of the target pixel can still be used as the center point. For example, the coordinate of the target pixel can be (1010,877). If the area compensation parameter is 3×5, then the target display area is (1010−1,877−2) to (1010+1,877+2). If the area compensation parameter is 3×17, the target display area is (1010−1,877−8) to (1010+1,877+8). If the area compensation parameter is 5×33, the target display area is, (1010−2,877−16) to (1010+2,877+16).

In order to better implement the embodiment of the present disclosure, in an embodiment of the present disclosure, the step of performing the brightness compensation on the target pixel comprises:
obtaining a preset weight corresponding to the target pixel; and compensating a gray value of the target pixel according to the preset weight.

In the actual implementation, when the difference between the target pixel and the overall image needs to be real-time calculated and the compensation voltage based on the difference needs to be immediately determined, it will still consume computing resources. Therefore, in order to further reduce the computational resources, the corresponding enhancement weight can be preset for each pixel. Specifically, the corresponding weights can be adjusted in advance according to the specifications of the display panel. For example, in a 4K display panel, the resolution is 3860×2160, so a corresponding weight for each pixel at each coordinate could be preset. In this case, when the coordinate corresponding to the target pixel are (1806, 1100), the preset weight corresponding to the coordinate could be obtained. Then, the brightness value corresponding to the target pixel is multiplied by the weight. For example, assuming that the brightness of the target pixel is J, the brightness J is multiplied by the weight K corresponding to the (1806, 1100) coordinate, and the target brightness value is obtained.

When the target brightness value is obtained, the brightness of the target display area can be compensated according to the charging voltage that matches the target brightness value. Here, the method of obtaining the target display area is the same as the above embodiment, and the details are omitted here.

In order to better implement the embodiment of the present disclosure, in an embodiment of the present disclosure, the step of compensating the gray value of the target pixel according to the preset weight comprises:
determining a second binding gray value of the target pixel, wherein the second binding gray value represents the preset reference binding gray value or an adjacent binding gray value of a matched target adjacent pixel; comparing the first binding gray value with the second binding gray value; when the first binding gray value is greater than the second binding gray value, obtaining a corresponding first preset weight and compensating the gray value of the target pixel accordingly; wherein the first preset weight is a positive number; and when the first binding gray value is then than the second binding gray value, obtaining a corresponding second preset weight and compensating the gray value of the target pixel accordingly; wherein the second preset weight is a negative number.

According to the above embodiment, the initial brightness value of the target pixel can be multiplied by the weight to obtain the target brightness value. However, in the actual implementation, the brightness of the target pixel value may be higher than the brightness of the overall image. In this case, it is necessary to reduce the brightness of the target pixel and the area corresponding to the target pixel value. Therefore, it is necessary to reduce the brightness of the target pixel. In this case, when the product of the target pixel and the weight is calculated to obtain the target brightness value, it is also necessary to determine whether the brightness of the target pixel increases or decreases according to the weight.

Specifically, in this embodiment, the binding gray values of the current pixel line where the target pixel point is located and an adjacent pixel line prior to the pixel row can be used to determine the compensation trend. For example, when the first binding gray value of the pixel row where the target pixel is located is less than the second binding gray value of the adjacent previous pixel row, it proves that the brightness of the target pixel needs to be enhanced, and when the first-bound grayscale value of the pixel row where the target pixel is located is greater than the second-bound grayscale value of the adjacent previous pixel row, the brightness of the target pixel needs to be reduced. If the brightness of the target pixel needs to be enhanced, the brightness of the target pixel and the weight can be multiplied according to the above embodiment. If the brightness of the target pixel needs to be reduced, the brightness of the target pixel is multiplied by (1−(weight−1)) to obtain the reduced target brightness value.

After the target brightness value is obtained, the compensation voltage is obtained according to the target brightness value according to the above-mentioned embodiment. And then the target display area is charged and compensated according to the compensation voltage, and further details are omitted here.

To sum up, the voltage compensation method according to an embodiment, can be summarized as follows: obtaining a target pixel, which can be any pixel in the display panel; determining the first binding gray value of the pixel row (column) where the target pixel is located, and determining the binding gray value of the previous pixel row (column) adjacent to the pixel row (column) where the target pixel is located; when there is no adjacent pixel row, obtaining the preset reference binding gray value; using the binding gray value or reference binding gray value of the adjacent previous pixel row (column) as the second binding gray value; calculating the first binding gray value and the second bound gray value; when the first binding gray value is greater than the second binding gray value, increasing the brightness of the target pixel. Specifically, the brightness of the target pixel is multiplied by the weight of the position corresponding to the target pixel to obtain the target brightness value. Thus, the compensation voltage corresponding to the target brightness value could be obtained.

After the compensation voltage is obtained, it is not necessary to compensate the voltage for each pixel in order to reduce the computational resource when the voltage compensation is performed. In this embodiment, an area compensation parameter can be determined based on the difference between the first binding gray value and the second binding gray value to determine a target display area, so that the brightness of each pixel in the target display area can be increased or decreased according to the compensation voltage. For example, please refer to Table 1 and Table 2, where Table 1 is a look up table for gray values of the target pixel, and Table 2 is a look up table for weights of the target pixel.

TABLE 1

| | | Binding gray value of the previous line | | | | | | |
|---|---|---|---|---|---|---|---|---|
| LOD table | | 0 | 16 | 32 | . . . | 224 | 240 | 255 |
| Binding | 0 | 0 | 0 | 0 | . . . | 0 | 0 | 0 |
| gray | 16 | 20 | 16 | 15 | . . . | 12 | 10 | 9 |
| value | 32 | 44 | 38 | 32 | . . . | 25 | 23 | 19 |
| of | . . . | . . . | . . . | . . . | . . . | . . . | . . . | . . . |
| current | 224 | 237 | 233 | 230 | . . . | 224 | 214 | 200 |
| line | 240 | 248 | 246 | 245 | . . . | 242 | 240 | 230 |
| | 255 | 255 | 255 | 255 | . . . | 255 | 255 | 255 |

TABLE 2

| | | Horizontal pixel distribution | | | | | | | | |
|---|---|---|---|---|---|---|---|---|---|---|
| Gain table | | 1 | . . . | 257 | . . . | 1920 | . . . | 3584 | . . . | 3840 |
| Vertical | 1 | 150% | . . . | 135% | . . . | 100% | . . . | 135% | . . . | 150% |
| pixel | . . . | . . . | . . . | . . . | . . . | . . . | . . . | . . . | . . . | . . . |
| distribu- | 257 | 140% | . . . | 125% | . . . | 100% | . . . | 125% | . . . | 140% |
| tion | . . . | . . . | . . . | . . . | . . . | . . . | . . . | . . . | . . . | . . . |
| | 1080 | 120% | . . . | 115% | . . . | 100% | . . . | 115% | . . . | 120% |
| | . . . | . . . | . . . | . . . | . . . | . . . | . . . | . . . | . . . | . . . |
| | 1904 | 140% | . . . | 125% | . . . | 100% | . . . | 125% | . . . | 140% |
| | . . . | . . . | . . . | . . . | . . . | . . . | . . . | . . . | . . . | . . . |
| | 2160 | 150% | . . . | 135% | . . . | 100% | . . . | 135% | . . . | 150% |

In order to better implement the embodiment of the present disclosure, in one embodiment, the voltage compensation method further comprises:

The gray value difference is negatively correlated with the number of pixels in the display area corresponding to the area compensation parameter; or the gray value difference is positively correlated with the number of areas in the display area corresponding to the area compensation parameter.

It is noted that the larger the gray value difference, the greater the difference between the adjacent rows of pixels. Therefore, in order to improve the accuracy of brightness compensation, a smaller area compensation parameter is required to avoid compensating for the same brightness of a large number of pixels. For example, when there is a large gray value difference between pixel rows, and when the area compensation parameter is still large, the compensation area may include a large number of pixels with large gray value differences. At this time, when the same brightness compensation is performed on a large number of pixels with large gray value differences, the compensation effect will be poor. Theoretically, in this case, it would be better to first make up the gray value difference so that the gray value difference is small, and then perform a unified brightness compensation such that the display effect could be better. Therefore, the larger the gray value difference, the smaller the area compensation parameter. This can avoid including a large number of pixels with large gray value difference into the compensation area, and alleviate the poor display effect caused by brightness compensation. Please refer to Table 3 below for details.

TABLE 3

| | | Horizontal pixel distribution | | | | | | | | | |
|---|---|---|---|---|---|---|---|---|---|---|---|
| Gain table | | 1 | 2 | 3 | 4 | 5 | 6 | 7 | 8 | . . . | 3840 |
| Vertical | 1 | Pixel A | 150% | 150% | . . . | . . . | . . . | . . . | . . . | . . . | . . . |
| pixel | 2 | 150% | 150% | 150% | . . . | . . . | . . . | . . . | . . . | . . . | . . . |
| distribution | 3 | 150% | 150% | 150% | . . . | . . . | . . . | . . . | . . . | . . . | . . . |
| | 4 | 150% | 150% | 150% | . . . | . . . | . . . | . . . | . . . | . . . | . . . |
| | 5 | 150% | 150% | 150% | . . . | . . . | . . . | . . . | . . . | . . . | . . . |
| | 6 | Pixel B | 130% | . . . | . . . | . . . | . . . | . . . | . . . | . . . | . . . |
| | 7 | 130% | 130% | . . . | . . . | . . . | . . . | . . . | . . . | . . . | . . . |
| | 8 | 130% | 130% | . . . | . . . | . . . | . . . | . . . | . . . | . . . | . . . |
| | . . . | . . . | . . . | . . . | . . . | . . . | . . . | . . . | . . . | . . . | . . . |
| | 2160 | . . . | . . . | . . . | . . . | . . . | . . . | . . . | . . . | . . . | . . . |

It should be noted that Table 3 and Table 2 both represent display panels of the same specification. According to Table 3, assuming that pixel A (1,1) exists. According to any of the above embodiments, assuming that the area compensation parameter corresponding to the gray value difference A of the pixel A is 3×5. Moreover, based on the position (1,1) in Table 2, the weight of the pixel A can be obtained as 150%. In this case, an area of 3×5 size can be determined based on the position of the pixel A, i.e. the coordinate (1,1). Here, the cells in Table 3 showing 150% represent the display area A of the pixel A, which is 3-unit long and 5-unit wide. In this case, the voltage corresponding to the weight of 150% could be used to compensate the brightness of the display area A.

Here, when another pixel B exists, the coordinate of pixel B is (6,1) according to Table 3. Based on the coordinate of the pixel B, according to Table 2, assuming that the weight corresponding to pixel B is 130%, and based on any of the above embodiment, the gray value difference B of the pixel B is obtained. Assuming that the gray value difference B is greater than the gray value difference A, so that the gray value difference B can correspond to a smaller area compensation parameter, such as 2×3. As shown in Table 3, for the display area B of pixel B, the brightness of the display area B can be compensated by the voltage corresponding to 130% of the weight. It can be seen that the larger the gray value difference, the smaller the area compensation parameter, and the smaller the number of pixels included in the display area corresponding to the area compensation parameter. Table 3 can represent the display panel after compensation.

Alternatively, in this embodiment, the area compensation parameter can represent a one-dimensional parameter, such as a parameter positively correlated with the number of areas in the display area. There is a positive correlation equation between the number of areas in the display area and the gray value difference. The gray value difference is input into the positive correlation equation to obtain an area division quantity, which is the area compensation parameter. As shown in Table 4, Table 4 and Table 2 represent display panels of the same specification. Here assuming that pixel A (1,1) exists. According to any of the above embodiments, assuming that the area compensation parameter corresponding to the gray value difference A of the pixel A is obtained as 2, and the weight of the pixel A can be obtained as 150% based on the position of (1,1) in Table 2. Accordingly, the entire display panel can be divided into areas using the area compensation parameter 2 according to the position of the pixel A, the coordinate of (1,1). For example, the cells in Table 4 showing 150% represent the display area A of the pixel A, where the size of the display area A has a length of 2. Accordingly, the voltage corresponding to the weight of 150% can be used to compensate the brightness of the display area A.

Furthermore, when the pixel B exists, according to Table 4, the coordinate of pixel B is (1,3). Based on the coordinate of the pixel B and the area compensation parameter 2, the display area B corresponding to the pixel B can be compensated. Table 4 can represent the display panel after compensation.

TABLE 4

| | | Horizontal pixel distribution | | | | | | | | | |
|---|---|---|---|---|---|---|---|---|---|---|---|
| Gain table | | 1 | 2 | 3 | 4 | 5 | 6 | 7 | 8 | . . . | 3840 |
| Vertical | 1 | Pixel A | 150% | Pixel B | 130% | . . . | . . . | . . . | . . . | . . . | . . . |
| pixel | 2 | 150% | 150% | 130% | 130% | . . . | . . . | . . . | . . . | . . . | . . . |
| distribution | 3 | 150% | 150% | 130% | 130% | . . . | . . . | . . . | . . . | . . . | . . . |
| | 4 | 150% | 150% | 130% | 130% | . . . | . . . | . . . | . . . | . . . | . . . |
| | 5 | 150% | 150% | 130% | 130% | . . . | . . . | . . . | . . . | . . . | . . . |
| | 6 | 150% | 150% | 130% | 130% | . . . | . . . | . . . | . . . | . . . | . . . |
| | 7 | 130% | 150% | 130% | 130% | . . . | . . . | . . . | . . . | . . . | . . . |
| | 8 | 150% | 150% | 130% | 130% | . . . | . . . | . . . | . . . | . . . | . . . |
| | . . . | 150% | 150% | 130% | 130% | . . . | . . . | . . . | . . . | . . . | . . . |
| | 2160 | 150% | 150% | 130% | 130% | . . . | . . . | . . . | . . . | . . . | . . . |

Alternatively, as shown in Table 5, Table 5 and Table 2 also represent the display panels of the same specification. Here, assuming the pixel A (1,1) exists. According to any the above embodiments, it is assumed that the gray value difference A of the pixel A is obtained and then input into the positive correlation equation to obtain the area compensation parameter 5. Moreover, based on the position (1,1) in Table 2, the weight of the pixel A can be obtained as 150%. In this case, a compensation area of 5 columns can be determined based on the position of the pixel A, i.e. the coordinate (1,1) as shown in the cells of 150% in Table 5, 150%. In this case, the voltage corresponding to the weight of 150% could be used to compensate the brightness of the display area A.

In addition, when the pixel B exists, according to Table 5, the coordinate of pixel B is (1,6). Based on the coordinate of the pixel B, and then based on the area compensation parameter of 5, the display area B corresponding to pixel B can be compensated. Table 5 can characterize the display panel after a display panel has been compensated.

TABLE 5

| | | Horizontal pixel distribution | | | | | | | | | |
|---|---|---|---|---|---|---|---|---|---|---|---|
| Gain table | | 1 | . . . | 5 | 6 | . . . | 10 | . . . | . . . | . . . | 3840 |
| Vertical | 1 | Pixel A | 150% | 150% | Pixel B | 130% | 130% | . . . | . . . | . . . | . . . |
| pixel | 2 | 150% | 150% | 150% | 130% | 130% | 130% | . . . | . . . | . . . | . . . |
| distribution | 3 | 150% | 150% | 150% | 130% | 130% | 130% | . . . | . . . | . . . | . . . |
| | 4 | 150% | 150% | 150% | 130% | 130% | 130% | . . . | . . . | . . . | . . . |
| | 5 | 150% | 150% | 150% | 130% | 130% | 130% | . . . | . . . | . . . | . . . |
| | 6 | 150% | 150% | 150% | 130% | 130% | 130% | . . . | . . . | . . . | . . . |
| | 7 | 130% | 150% | 150% | 130% | 130% | 130% | . . . | . . . | . . . | . . . |
| | 8 | 150% | 150% | 150% | 130% | 130% | 130% | . . . | . . . | . . . | . . . |
| | . . . | 150% | 150% | 150% | 130% | 130% | 130% | . . . | . . . | . . . | . . . |
| | 2160 | 150% | 150% | 150% | 130% | 130% | 130% | . . . | . . . | . . . | . . . |

Assuming that the binding gray value of the previous pixel row of the target pixel is 0, and the binding gray value of the current pixel row is 16. Based on Table 1, we can get that the corresponding value of the target pixel is 20. In this case, we can use 20-16 to obtain the brightness corresponding to the current target pixel as 4. That is, the gamma value is 4. Moreover, according to Table 2, the coordinate of the target pixel is (1920, 1080), and the weight corresponding to the coordinate (1920, 1080) is 100%. Accordingly, we can refer to the following equation (1):

$${LOD}_{final} = LOD \times Gain . \qquad ( 1 )$$

As shown in equation (1), wherein LOD is the brightness of the target pixel, which is 4 in this embodiment, Gain is the weight corresponding to the position of the target pixel, which is 100% in this embodiment, and the target brightness can be obtained according to equation (1) is still 4. However, it is also necessary to determine the target display area that includes the target pixel. In this case, the area compensation parameter ACP could be calculated according to equation (2) below:

$$ACP = \{ \begin{matrix}gain lut 1 , & 0 \leq \vert {data}_{current line} - {data}_{pre line} \vert \leq a \\ gain lut 2 , & a < \vert {data}_{current line} - {data}_{pre line} \vert \leq b \\ gain lut 3 , & b < \vert {data}_{current line} - {data}_{pre line} \vert \leq 255\end{matrix} , \qquad ( 2 )$$

where data_{current line} is the first binding gray value. data_{pre line} is the second binding gray value. a and b are respectively the difference thresholds of the previous row of data and the current line of data, which can be set according to the charging situation of the panel. gain lut1, gain lut2 and gain lut3 can also be set according to the specific situation, and further details are not limited here. Therefore, according to equation (2), the target display area corresponding to the target pixel can be obtained. It should be noted that in this embodiment, after the voltage compensation is performed on the target display area, the pixels in the target display area will no longer be used as another target pixel to be compensated to determine whether voltage compensation is required. In this case, the pixel outside the target display area is selected as the target pixel to be compensated. If a pixel outside the target display area is used as the target pixel to be compensated, and another target display area is obtained, when there is an overlap between the other target display area and the previous target display area, the overlap will be removed from the other target display area to avoid repeated charging compensation. In this way, the entire display panel can be charged and compensated at one time. It could avoid calculating whether a compensation is needed for each and every pixel, and the overlapping parts of the target display areas are not compensated repeatedly.

In addition, in an embodiment, another method is disclosed. Based on the above embodiment, the method is: “when the first binding gray value is less than the second binding gray value, according to the preset weight, determining the brightness reduction value of the target pixel; and according to the brightness reduction value, reducing and adjusting the brightness value of the target pixel to obtain the target brightness value”. However, this step could be adjusted by adjusting the equation (1). That is, the equation (1) can be changed to the following equation (3):

$${LOD}_{final} = - LOD \times Gain . \qquad ( 3 )$$

Equation (3) adds a negative sign compared to Equation (1), and the obtained brightness is a negative value, so that the brightness can be reduced. For example, when the weight of the current target pixel is 100%, and when the gamma value of the current target pixel is 4, but it is determined that the brightness of the current target pixel needs to be reduced according to the weight, then the equation (3) is applied and it becomes −4×100%=−4. This means that the gamma value of 4 needs to be reduced for the current target pixel.

In addition, it should be noted that in the above embodiment, a binding gray value based on the previous line of the target pixel and the binding gray value of the current line are used in the equation (1) or equation (3) determine LOD_{final}. Furthermore, in this embodiment, other factual methods are also provided, as shown in Table 6:

TABLE 6

| | | Horizontal pixel distribution | | | | | | | | |
|---|---|---|---|---|---|---|---|---|---|---|
| Gain table | | 1 | . . . | 257 | . . . | 1920 | . . . | 3584 | . . . | 3840 |
| Horizontal | 1 | 150% | . . . | 135% | . . . | 100% | . . . | 135% | . . . | 150% |
| pixel | . . . | . . . | . . . | . . . | . . . | . . . | . . . | . . . | . . . | . . . |
| distribu- | 257 | 140% | . . . | 125% | . . . | 100% | . . . | 125% | . . . | 140% |
| tion | . . . | . . . | . . . | . . . | . . . | . . . | . . . | . . . | . . . | . . . |
| | 1080 | 120% | . . . | 115% | . . . | 100% | . . . | 115% | . . . | 120% |
| | . . . | . . . | . . . | . . . | . . . | . . . | . . . | . . . | . . . | . . . |
| | 1904 | 140% | . . . | 125% | . . . | 100% | . . . | 125% | . . . | 140% |
| | . . . | . . . | . . . | . . . | . . . | . . . | . . . | . . . | . . . | . . . |
| | 2160 | 150% | . . . | 135% | . . . | 100% | . . . | 135% | . . . | 150% |

Table 6 represents a weight table used when the binding gray value of the previous row of the target pixel is greater than the binding gray value of the current row. Assuming that the binding gray value of the previous row of the pixel A is greater than the binding gray value of the current row, then find the coordinate of the pixel A in Table 6. Assuming that the coordinate of the pixel A is (1,1), then the weight value of pixel A is 150%, and then input 150% into the above equation (1) to obtain LOD_{final} of the pixel A.

Or, as shown in Table. 7:

TABLE 7

| | | Horizontal pixel distribution | | | | | | | | |
|---|---|---|---|---|---|---|---|---|---|---|
| Gain table | | 1 | . . . | 257 | . . . | 1920 | . . . | 3584 | . . . | 3840 |
| Horizontal | 1 | 90% | . . . | 85% | . . . | 100% | . . . | 85% | . . . | 90% |
| pixel | . . . | . . . | . . . | . . . | . . . | . . . | . . . | . . . | . . . | . . . |
| distribu- | 257 | 80% | . . . | 75% | . . . | 100% | . . . | 75% | . . . | 80% |
| tion | . . . | . . . | . . . | . . . | . . . | . . . | . . . | . . . | . . . | . . . |
| | 1080 | 70% | . . . | 70% | . . . | 100% | . . . | 70% | . . . | 70% |
| | . . . | . . . | . . . | . . . | . . . | . . . | . . . | . . . | . . . | . . . |
| | 1904 | 80% | . . . | 75% | . . . | 100% | . . . | 75% | . . . | 80% |
| | . . . | . . . | . . . | . . . | . . . | . . . | . . . | . . . | . . . | . . . |
| | 2160 | 90% | . . . | 85% | . . . | 100% | . . . | 85% | . . . | 90% |

Table 7 represents a weight table used when the binding gray value of the previous row of the target pixel is less than the binding gray value of the current row. Assuming that the binding gray value of the previous row of the pixel A is less than the binding gray value of the current row, then find the coordinate of the pixel A in Table 7. Assuming that the coordinate of the pixel A is (1,1), then the weight value of pixel A is 90%, and then input 90% into the above equation (1) to obtain LOD_{final} of the pixel A.

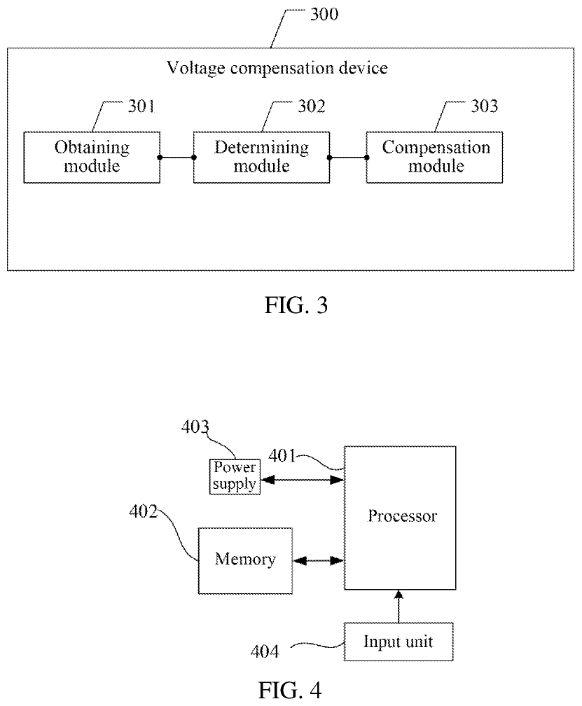

In order to better implement the embodiment of the present disclosure, based on the voltage compensation method, another embodiment of the present disclosure provides a voltage compensation device. As shown in FIG. 3, the voltage compensation device 300 comprises an obtaining module 301, a determining module 302 and a compensation module 303.

The obtaining module 301 is used for obtaining pixel information and position information of a target pixel to be compensated.

The determining module 302 is used for determining an area compensation parameter corresponding to the target pixel according to the pixel information.

The compensation module 303 is used for performing a brightness compensation on the target pixel according to the position information of the target pixel in a display panel and the area compensation parameter.

In this embodiment, the voltage compensation device 300 could use the determining module 302 to determine an area compensation parameter according to the pixel information of the target pixel after the module 301 obtains the pixel information of the target pixel such that a target display area in a display panel could be obtained. Then, the target display area can be compensated by the compensation module 303. Thus, there is no need to perform the compensation on each and every pixel, thereby reducing the computational burden.

In some embodiments of the present disclosure, the determining module 302 is further used for:
determining whether the target pixel has a matched target adjacent pixel;
when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel;
determining the area compensation parameter corresponding to the target pixel according to a gray difference between the first binding gray value and the adjacent binding gray value.

In some embodiments of the present disclosure, the determining module 302 is further used for:
determining a target pixel row in which the target pixel is located;
obtaining a previous pixel row adjacent to the target pixel row;
determining a target adjacent pixel that is a pixel in the adjacent previous pixel row that matches the target pixel.

In some embodiments, the determining module 302 is further used for:
obtaining a preset reference binding gray value when the target pixel does not have a matched target adjacent pixel;
determining the area compensation parameter corresponding to the target pixel according to a gray difference between the first binding gray value and the reference binding gray value.

In some embodiments of the present disclosure, the compensation module 303 is further used for:
determining a regional center point according to the position information of the target pixel in the display panel;
determining a target display area according to the regional center point and the area compensation parameter;
performing the brightness compensation on the target pixel in the target display area.

In some embodiments of the present disclosure, the compensation module 303 is further used for:
obtaining a preset weight corresponding to the target pixel;
compensating a gray value of the target pixel according to the preset weight.

In some embodiments of the present disclosure, the compensation module 303 is further used for:
determining a second binding gray value of the target pixel, where the second binding gray value represents the preset reference binding gray value or an adjacent binding gray value of a matched target adjacent pixel;
comparing the first binding gray value with the second binding gray value;
when the first binding gray value is greater than the second binding gray value, obtaining a corresponding first preset weight and compensating the gray value of the target pixel accordingly, where the first preset weight is a positive number;
when the first binding gray value is then than the second binding gray value, obtaining a corresponding second preset weight and compensating the gray value of the target pixel accordingly, where the second preset weight is a negative number.

According to an embodiment of the present disclosure, a terminal device is disclosed. The terminal device comprises a memory and a processor. The memory stores a computer program. The processor is configured to execute the computer program to perform any step of a voltage compensation method of any of the above embodiments. The terminal device integrates a voltage compensation method of any of the above embodiments of the present disclosure. Please refer to FIG. 4. FIG. 4 is a functional block diagram of a terminal device according to an embodiment of the present disclosure.

Specifically, the terminal device may include a processor 401 having one or more processing cores, a memory 402 having one or more computer-readable storage media, a power supply 403 and an input unit 404. A person having ordinary skills in the art can understand that the structure of the terminal device shown in FIG. 4 is not a limitation of the terminal device. In the actual implementation, the terminal device could include more or fewer parts, include a combination of some of the parts or have arrangement of these parts.

The processor 401 is a control center of the terminal device, using various interfaces and wirings to connect various parts of the entire terminal device. The processor 401 executes and calls computer software program instructions and/or modules stored in the memory 402 to perform various functions of the terminal device and process data, thereby monitoring the terminal device. Optionally, the processor 401 may include one or more processing cores. The processor 401 may be a Central Processing Unit (CPU), or other general-purpose processor, Digital Signal Processor (DSP), Application Specific Integrated Circuit (ASIC), Field-Programmable Gate Array (FPGA) or other programmable logic devices, discrete gate or transistor logic devices, discrete hardware components, etc. The general processor can be a microprocessor or any conventional processor. Preferably, an application processor and a modem processor can be integrated in the processor 401, where the application processor mainly processes an operating system, user interfaces and applications. The modem processor handles wireless communications. It can be understood that the above modem processor may not be integrated into the processor 401.

The memory 402 can be used to store computer software program instructions and modules. The processor 401 executes and calls computer software program instructions and/or modules stored in the memory 402 to perform various functions of the terminal device and process data. The memory 402 may include a storage program area and a storage data area, where the storage program area may store the operating system, and application program to realize at least one function (such as a sound playback function and an image playback function). The storage data area may store data created by the use of terminal device. In addition, the memory 402 may include high-speed random access memory and non-volatile memory, such as at least one magnetic disk storage device, flash memory device, or other volatile solid-state storage device. Accordingly, the memory 402 may also include a memory controller to control the processor 401 to access the memory 402.

The terminal device also includes a power supply 403 that supplies power to various components. Preferably, the power supply 403 can be logically connected to the processor 401 through a power management system, so that functions such as charging, discharging, and power consumption management can be implemented through the power management system. The power supply 403 may also include one or more direct current (DC) or alternate current (AC) power supplies, recharging systems, power failure detection circuits, power converters or inverters, power status indicators, and other arbitrary components.

The terminal device may also include an input unit 404 that may be used to receive input numeric or character information and generate input related to user settings and function control in response to triggers of a keyboard, a mouse, a joystick, an optical or trackball.

The terminal device may also include a display unit and the like, which will not be described again here. In this embodiment, the processor 401 in the terminal device loads the executable file corresponding to the process of one or more computer program instructions into the memory 402, and the processor 401 runs the computer program instructions stored in the memory 402 to perform various functions, including:
obtaining pixel information and position information of a target pixel to be compensated;
determining an area compensation parameter corresponding to the target pixel according to the pixel information;
performing a brightness compensation on the target pixel according to the position information of the target pixel in a display panel and the area compensation parameter.

A person having ordinary skills in the art may understand that all or a part of the steps in the voltage compensation method of any of the above embodiments may be completed by instructions or by instruction control related hardware, and the instructions may be stored in a computer-readable storage medium and loaded and executed by a processor.

Another embodiment of the present disclosure provides a computer-readable storage medium, which may include: Read-Only Memory (ROM), Random Access Memory (RAM), magnetic disk or optical disk, etc. The processor executes computer program instructions stored in the computer-readable storage medium to perform steps in any voltage compensation method provided by the embodiments of the present disclosure. For example, the computer program instructions executable by the processor to perform operations comprising:
obtaining pixel information and position information of a target pixel to be compensated;
determining an area compensation parameter corresponding to the target pixel according to the pixel information;
performing a brightness compensation on the target pixel according to the position information of the target pixel in a display panel and the area compensation parameter.

In the above embodiments, each embodiment is described with its own emphasis. For parts that are not described in detail in a certain embodiment, please refer to the above detailed descriptions of other embodiments and will not be described again.

During specific implementation, each of the above units or structures can be implemented as an independent entity, or can be combined in any way and implemented as the same or several entities. For the specific implementation of each of the above units or structures, please refer to the previous method embodiments and will not be described again.

For the specific implementation of each of the above operations, please refer to the previous embodiments and will not be described again.

The above is a voltage compensation method and a device provided by an embodiment of the present disclosure is described in detail, and a specific example is applied herein to explain the principle and embodiment of the present disclosure, and the description of the above embodiment is only used to help understand the method of the present disclosure and its core ideas. At the same time, for those skilled in the art, according to the idea of the present disclosure, there will be changes in the specific embodiment and the scope of present disclosure, in summary, the content of this specification should not be understood as a restriction on the present disclosure.

1. A voltage compensation method, comprising:
obtaining pixel information and position information of a target pixel to be compensated;
determining an area compensation parameter corresponding to the target pixel according to the pixel information; and
performing a brightness compensation on the target pixel according to the position information of the target pixel in a display panel and the area compensation parameter.

2. The voltage compensation method of claim 1, wherein the pixel information comprises a first binding gray value of the target pixel, and the step of determining the area compensation parameter corresponding to the target pixel according to the pixel information comprises:
determining whether the target pixel has a matched target adjacent pixel;
when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel; and
determining the area compensation parameter corresponding to the target pixel according to a gray difference between the first binding gray value and the adjacent binding gray value.

3. The voltage compensation method of claim 2, wherein the gray difference is negatively correlated with a number of pixels in the display area corresponding to the area compensation parameter; or, the gray scale difference is positively correlated with a number of areas in the display area corresponding to the area compensation parameter.

4. The voltage compensation method of claim 2, further comprising following steps after the step of determining whether the target pixel has a matched target adjacent pixel:
when the target pixel does not have a matched target adjacent pixel, obtaining a preset reference binding gray value; and
determining the area compensation parameter corresponding to the target pixel according to a gray difference between the first binding gray value and the reference binding gray value.

5. The voltage compensation method of claim 1, wherein the step of performing the brightness compensation on the target pixel according to the position information of the target pixel in the display panel and the area compensation parameter comprises:
according to the position information of the target pixel in the display panel, determining a regional center point;
determining a target display area according to the regional center point and the area compensation parameter; and
performing the brightness compensation on the target pixel in the target display area.

6. The voltage compensation method of claim 1, wherein the step of performing the brightness compensation on the target pixel comprises:
obtaining a preset weight corresponding to the target pixel; and
compensating a gray value of the target pixel according to the preset weight.

7. The voltage compensation method of claim 6, wherein the step of compensating the gray value of the target pixel according to the preset weight comprises:
determining a second binding gray value of the target pixel, wherein the second binding gray value represents the preset reference binding gray value or an adjacent binding gray value of a matched target adjacent pixel;
comparing the first binding gray value with the second binding gray value;
when the first binding gray value is greater than the second binding gray value, obtaining a corresponding first preset weight and compensating the gray value of the target pixel accordingly; wherein the first preset weight is a positive number; and
when the first binding gray value is then than the second binding gray value, obtaining a corresponding second preset weight and compensating the gray value of the target pixel accordingly, where the second preset weight is a negative number.

8-14. (canceled)

15. A terminal device, comprising a processor and a memory storing computer program instructions executable by the processor to perform operations comprising:
obtaining pixel information and position information of a target pixel to be compensated;
determining an area compensation parameter corresponding to the target pixel according to the pixel information; and
performing a brightness compensation on the target pixel according to the position information of the target pixel in a display panel and the area compensation parameter.

16. A non-transitory computer readable storage medium, storing in computer program instructions executable by a processor to perform operations comprising:
obtaining pixel information and position information of a target pixel to be compensated;
determining an area compensation parameter corresponding to the target pixel according to the pixel information; and
performing a brightness compensation on the target pixel according to the position information of the target pixel in a display panel and the area compensation parameter.

17. The non-transitory computer readable storage medium of claim 16, wherein the pixel information comprises a first binding gray value of the target pixel, and an operation of determining the area compensation parameter corresponding to the target pixel according to the pixel information comprises:
determining whether the target pixel has a matched target adjacent pixel;
when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel; and
determining the area compensation parameter corresponding to the target pixel according to a gray difference between the first binding gray value and the adjacent binding gray value.

18. The non-transitory computer readable storage medium of claim 17, wherein the gray difference is negatively correlated with a number of pixels in the display area corresponding to the area compensation parameter; or, the gray scale difference is positively correlated with a number of areas in the display area corresponding to the area compensation parameter.

19. The non-transitory computer readable storage medium of claim 17, further comprising following operations after an operation of determining whether the target pixel has a matched target adjacent pixel:
when the target pixel does not have a matched target adjacent pixel, obtaining a preset reference binding gray value; and
determining the area compensation parameter corresponding to the target pixel according to a gray difference between the first binding gray value and the reference binding gray value.

20. The non-transitory computer readable storage medium of claim 16, wherein an operation of performing the brightness compensation on the target pixel according to the position information of the target pixel in the display panel and the area compensation parameter comprises:
according to the position information of the target pixel in the display panel, determining a regional center point;
determining a target display area according to the regional center point and the area compensation parameter; and
performing the brightness compensation on the target pixel in the target display area.

21. The non-transitory computer readable storage medium of claim 16, wherein an operation of performing the brightness compensation on the target pixel comprises:
obtaining a preset weight corresponding to the target pixel; and
compensating a gray value of the target pixel according to the preset weight.

22. The non-transitory computer readable storage medium of claim 21, wherein an operation of compensating the gray value of the target pixel according to the preset weight comprises:
determining a second binding gray value of the target pixel, wherein the second binding gray value represents the preset reference binding gray value or an adjacent binding gray value of a matched target adjacent pixel;
comparing the first binding gray value with the second binding gray value;
when the first binding gray value is greater than the second binding gray value, obtaining a corresponding first preset weight and compensating the gray value of the target pixel accordingly; wherein the first preset weight is a positive number; and
when the first binding gray value is then than the second binding gray value, obtaining a corresponding second preset weight and compensating the gray value of the target pixel accordingly, where the second preset weight is a negative number.

23. The terminal device of claim 15, wherein the pixel information comprises a first binding gray value of the target pixel, and an operation of determining the area compensation parameter corresponding to the target pixel according to the pixel information comprises:
determining whether the target pixel has a matched target adjacent pixel;
when the target pixel has a matched target adjacent pixel, obtaining an adjacent binding gray value of the target adjacent pixel and the first binding gray value of the target pixel, wherein a pixel corresponding to the target pixel in a preceding pixel row adjacent to a target pixel row where the target pixel is located is the matched target adjacent pixel; and
determining the area compensation parameter corresponding to the target pixel according to a gray difference between the first binding gray value and the adjacent binding gray value.

24. The terminal device of claim 23, wherein the gray difference is negatively correlated with a number of pixels in the display area corresponding to the area compensation parameter; or, the gray scale difference is positively correlated with a number of areas in the display area corresponding to the area compensation parameter.

25. The terminal device of claim 23, further comprising following operations after an operation of determining whether the target pixel has a matched target adjacent pixel:
when the target pixel does not have a matched target adjacent pixel, obtaining a preset reference binding gray value; and
determining the area compensation parameter corresponding to the target pixel according to a gray difference between the first binding gray value and the reference binding gray value.

26. The terminal device of claim 15, wherein an operation of performing the brightness compensation on the target pixel according to the position information of the target pixel in the display panel and the area compensation parameter comprises:
according to the position information of the target pixel in the display panel, determining a regional center point;
determining a target display area according to the regional center point and the area compensation parameter; and
performing the brightness compensation on the target pixel in the target display area.

27. The terminal device of claim 15, wherein an operation of performing the brightness compensation on the target pixel comprises:
obtaining a preset weight corresponding to the target pixel; and
compensating a gray value of the target pixel according to the preset weight.
